(19) United States
(12) Patent Application Publication
(10) Pub. No.: US 2009/0267588 A1
(43) Pub. Date: Oct. 29, 2009

(54) METHOD AND APPARATUS TO DYNAMICALLY CONTROL IMPEDANCE TO MAXIMIZE POWER SUPPLY

(76) Inventors: Michael J. Schmitz, Fargo, ND (US); Joel A. Jorgenson, Fargo, ND (US)

Correspondence Address: BLAKELY SOKOLOFF TAYLOR & ZAFMAN LLP, 1279 OAKMEAD PARKWAY, SUNNYVALE, CA, 94085-4040, US

(21) Appl. No.: 12/426,110

(22) Filed: Apr. 17, 2009

Related U.S. Application Data
(60) Provisional application No. 61/047,329, filed on Apr. 23, 2008.

(51) Int. Cl. G05B 24/02; H02J 1/00

(52) U.S. Cl. 323/352

(57) ABSTRACT

An apparatus and method for dynamically controlling impedance to maximize the transfer of energy from energy source(s) to load(s). In a system with a load, an energy source, and a power distribution network (PDN) coupled between the energy source and the load, system conditions and environmental changes of the system are monitored. Using a variable impedance circuit, the impedance of the PDN can be dynamically controlled such that the transfer of energy from the energy source(s) to the load(s) is increased.

### REFERENCE TO RELATED APPLICATION

This application claims the benefit of U.S. Provisional Patent Application No. 61/047,329, filed on Apr. 23, 2008.

### TECHNICAL FIELD

The present invention relates generally to power management, and in particular to tracking changes in impedance of energy source(s) and load(s) to maximize the transfer of energy from energy source(s) to the load(s).

### BACKGROUND

Today, the use of portable or mobile electronic devices (e.g., laptop computers, cellular telephones, personal digital assistants, portable media player, etc.) becomes more and more popular. Most portable electronic devices rely on local energy source(s) for the supply of energy, such as batteries. Because of the limited energy storage capacity of batteries, many techniques have been developed to optimize or minimize energy usage in portable electronic devices by managing the loads in the portable electronic devices.

FIG. 1 illustrates one conventional power distribution system. Referring to FIG. 1, there are one or more energy sources 101, one or more electronic loads 108 (or simply referred to as loads), and a power distribution network (PDN) between the energy sources 101 and the loads 108. The PDN includes a filter and energy storage 104, a voltage regulation module 105, and an energy storage 106 of the filtered voltage supply, coupled to each other via some interconnect, wiring, and/or transmission lines 102, 103, and 107. The power distribution system supplies energy to the loads from the sources through the PDN. The PDN is typically designed based on the demands of the loads.

As the power demands and clock speeds of the loads have increased, the design of a quality PDN has become increasingly important.

### BRIEF DESCRIPTION OF THE DRAWINGS

The present invention is illustrated by way of example, and not of limitation, in the figures of the accompanying drawings in which:

FIG. 1 illustrates a conventional power distribution system;

FIG. 2 illustrates one embodiment of a power distribution system;

FIG. 3 illustrates a first embodiment of a variable impedance circuit;

FIG. 4 illustrates a second embodiment of a variable impedance circuit;

FIG. 5A illustrates a third embodiment of a variable impedance circuit;

FIG. 5B illustrates an alternate embodiment of a power distribution system;

FIGS. 6A-6C illustrate some embodiments of a dynamic impedance circuit;

FIG. 7 illustrates one embodiment of a process to maximize energy supply; and

FIG. 8 illustrates a diagrammatic representation of a machine in the exemplary form of a computer system.

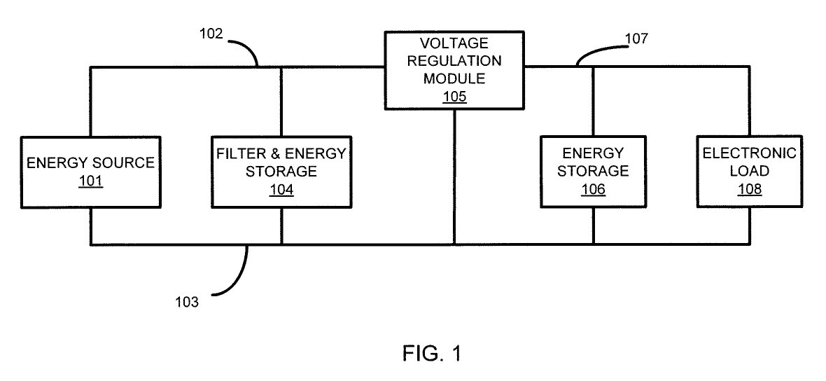

### DETAILED DESCRIPTION

In the following description, numerous specific details are set forth such as examples of specific components, devices, methods, etc., in order to provide a thorough understanding of embodiments of the present invention. It will be apparent, however, to one skilled in the art that these specific details need not be employed to practice embodiments of the present invention. In other instances, well-known materials or methods have not been described in detail in order to avoid unnecessarily obscuring embodiments of the present invention. It should be noted that the “line” or “lines” discussed herein, that connect elements, may be single lines or multiple lines. It will also be understood by one having ordinary skill in the art that lines and/or other coupling elements may be identified by the nature of the signals they carry (e.g., a “clock line” may implicitly carry a “clock signal” ) and that input and output ports may be identified by the nature of the signals they receive or transmit (e.g., “clock input” may implicitly receive a “clock signal”).

Various embodiments of an apparatus and a method to dynamically control impedance are described below. In one embodiment, one or more conditions of at least one of the loads and energy sources are monitored. Based on the result of monitoring, an optimal mode of energy draw from one or more energy sources is determined. Then the impedance of the power distribution network is adjusted to allow maximum transfer of energy from the sources to the loads. In some embodiments, the impedance is continuously adjusted to match the impedance of the energy sources to the loads. Alternatively, the impedance is adjusted at one or more predetermined times.

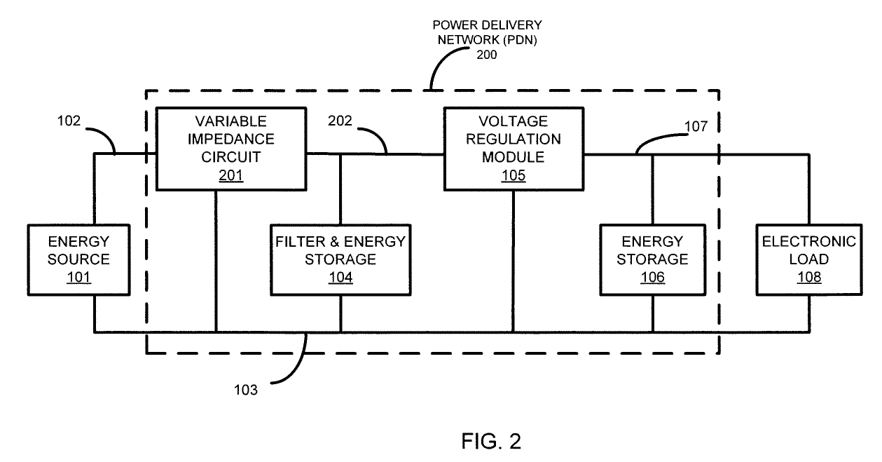

FIG. 2 illustrates one embodiment of a power distribution system. The power distribution system may be implemented within an electronic device or machine, which may include portable devices (e.g., laptop computer, PDAs, cellular telephones, media players, etc.). Referring to FIG. 2, the power distribution system includes one or more energy sources 101, one or more electronic loads 108 (or simply referred to as loads), and a power distribution network (PDN) 200 between the energy sources 101 and the loads 108. The PDN 200 includes a variable impedance circuit 201, a filter and energy storage 104, a voltage regulation module 105, and an energy storage 106 of filtered voltage supply, coupled to each other via some interconnect, wiring, and/or transmission lines 202, 102, 103, and 107.

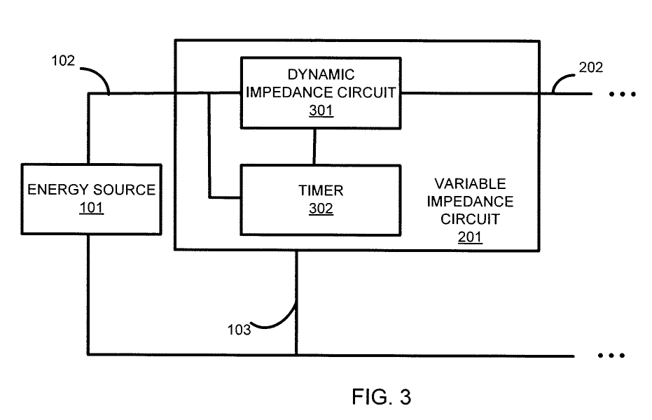

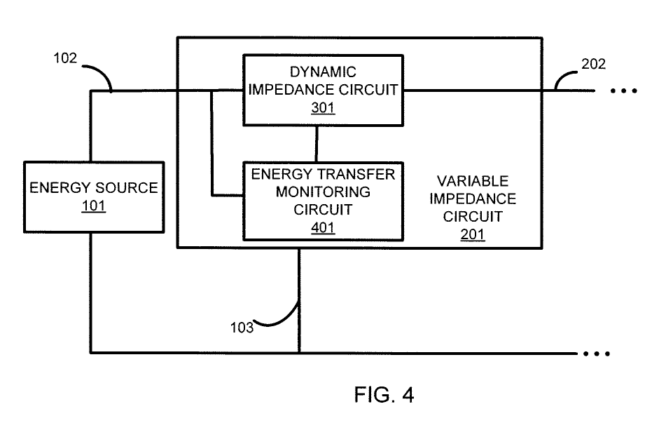

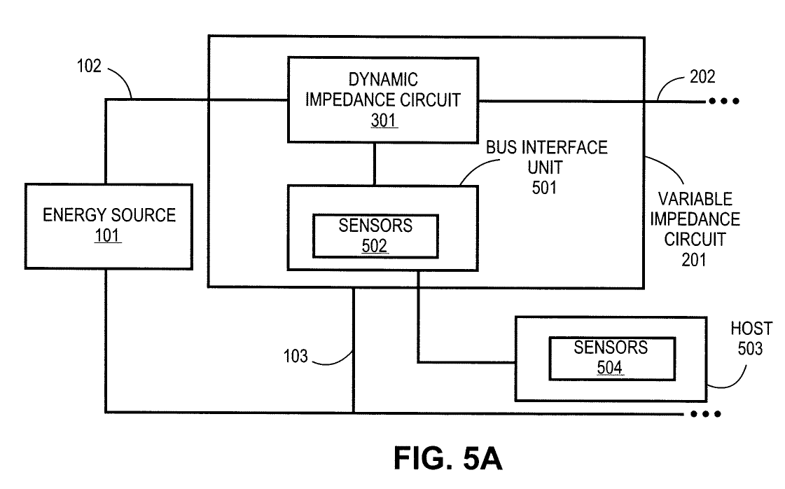

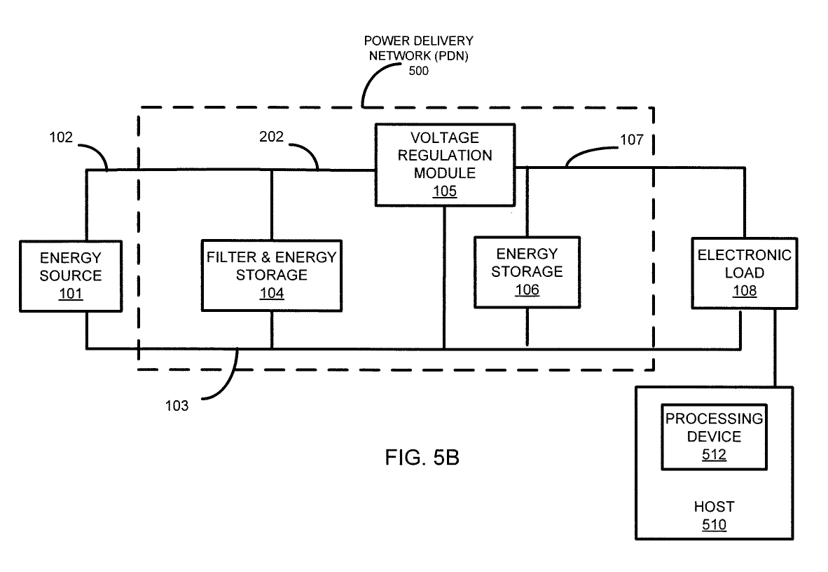

In some embodiments, the energy source 101 is the primary energy source of the system. For example, the energy source 101 may include a battery where the system is in a portable device. In other embodiments, the energy source 101 may include a fuel cell, solar cell, alternate current (AC) source, or other energy sources, etc. The impedance of the energy source 101 varies over time. Thus, to maximize the transfer of energy from the energy source 101 to the loads 108, the variable impedance circuit 201 is dynamically controlled to match the impedance of the power distribution network and load(s) to the varying source impedance over time, usage, and/or environmental changes. In some embodiments, the variable impedance circuit 201 is controlled in an autonomous mode. More details of some embodiments of the variable impedance circuit 201 controlled in an autonomous mode are discussed below with reference to FIGS. 3 and 4. Alternatively, the variable impedance circuit 201 is controlled in a commanded mode. More details of one embodiment of the variable impedance circuit 201 in a commanded mode are discussed below with reference to FIG. 5A. The variable impedance circuit 201 is further coupled to the filter and energy storage 104 and the voltage regulation module 105 via the interconnect 202. The interconnect 202 may include transmission lines, wiring, etc.

The filter and energy storage 104 may include voltage suppression circuits, capacitors, and local storage elements. In addition, the filter and energy storage 104 includes circuitry to prevent dangerous over voltage or under voltage conditions. The voltage regulation module 105 converts the raw energy to a filtered and regulated supply, with provisions and circuitry for safety, regulation, and reliable system operation. The voltage regulation module 105 is further coupled to the energy storage 106 and the loads 108 via the interconnect 107. The interconnect 107 may include transmission lines, wiring, etc.

In some embodiments, the energy storage 106 stores the filtered voltage supply from the voltage regulation module 105. The loads 108 use or consume the energy for application demand and user requests.

FIG. 3 illustrates a first embodiment of the variable impedance circuit 201. Referring to FIG. 3, the variable impedance circuit 201 includes a dynamic impedance circuit 301 coupled to a timer 302. Thus, the variable impedance circuit 201 may also be referred to as a time-based variable impedance circuit. In some embodiments, prior study may be conducted to determine the general trend of impedance variation of the energy source 101 over time. Based on such study, the impedance of the dynamic impedance circuit 301 may be set to increase or decrease at a predetermined time in order to better match with the impedance of the energy source 101. For example, the dynamic impedance circuit 301 may be set to switch in one or more circuit components (e.g., tunable or variable inductors) at a predetermined time to increase the impedance of the dynamic impedance circuit 301. The timer 302 is used to keep track of time. In some embodiments, the timer 302 may include one or more counters.

FIG. 4 illustrates a second embodiment of the variable impedance circuit 201. Referring to FIG. 4, the variable impedance circuit 201 includes a dynamic impedance circuit 301 coupled to an energy transfer monitoring circuit (e.g., a coulomb counting circuit, an energy source voltage measuring circuit, an energy source impedance measuring circuit, etc.) 401. In some embodiments, the energy transfer monitoring circuit 401 is used to monitor the energy output of the energy source 101. Based on the measurement, the impedance of the variable impedance circuit 201 is tuned to increase the transfer of energy from the energy source 101 to the loads 108.

FIG. 5A illustrates a third embodiment of the variable impedance circuit 201. Referring to FIG. 5A, the variable impedance circuit 201 includes a dynamic impedance circuit 301 coupled to a bus interface unit 501. In some embodiments, the bus interface unit 501 is further coupled to a host 503 to receive commands from the host 503. In some embodiments, the host 503 includes sensors 504 to monitor one or more system conditions (e.g., voltage, current, frequency, etc.) and environmental changes (e.g., temperature change, humidity change, etc.) and sends appropriate commands to the bus interface unit 501 based on the results of the monitoring. The bus interface unit 501 may forward the commands to the dynamic impedance circuit 301 or sends control signals to the dynamic impedance circuit 301 in response to the commands. In some embodiments, the bus interface unit 501 also includes one or more sensors 502 to monitor one or more system conditions (e.g., voltage, current, frequency, etc.) and environmental changes (e.g., temperature change, humidity change, etc.) such that the bus interface unit 501 may send commands or control signals to the dynamic impedance circuit 301 based on results of its own monitoring as well. In response to the control signals or commands from the bus interface unit 501, the dynamic impedance circuit 301 adjusts its impedance accordingly in order to better match the impedance of the energy source 101 and loads 108.

Alternatively, the host 503 may include a processing device to execute an algorithm to determine an appropriate dynamic impedance value based on measured parameters. The host 503 may communicate the appropriate dynamic impedance value determined to the dynamic impedance circuit 301 to cause the dynamic impedance circuit 301 to adjust the impedance.

FIG. 5B illustrates an alternate embodiment of a power distribution system. The power distribution system includes an energy source 101, an electronic load 108, and a power delivery network (PDN) 500 coupled between the energy source 101 and the electronic load 108. The electronic load 108 is further coupled to a host 510, which includes a processing device 512. The PDN 500 includes a filter and energy storage 104, a voltage regulation module 105, and energy storage 106, coupled to each other via some interconnect, wiring, and/or transmission lines 202, 102, 103, and 107.

In some embodiments, the energy source 101 is the primary energy source of the system. For example, the energy source 101 may include a battery where the system is in a portable device. In other embodiments, the energy source 101 may include a fuel cell, solar cell, alternate current (AC) source, or other energy sources, etc. The impedance of the energy source 101 varies over time. Thus, to maximize the transfer of energy from the energy source 101 to the electronic load 108, the processing device 512 in the host 510 may execute a software routine that, through methods of load control or processor frequency and voltage adjustment, could vary the impedance of the electronic load 108 in order to substantially match the impedance of the energy source 101.

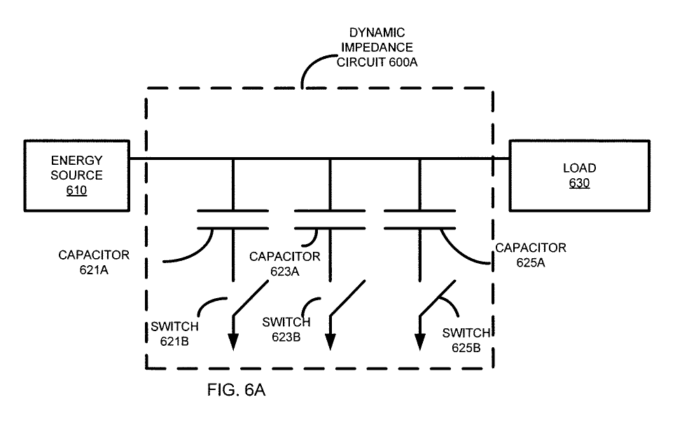

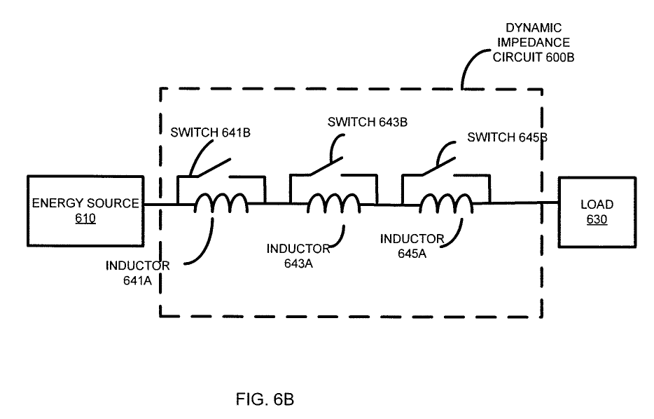

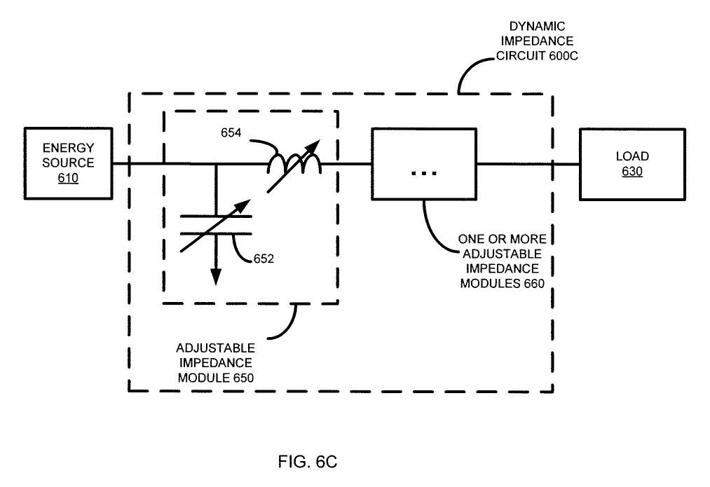

FIGS. 6A-6C illustrate some embodiments of a dynamic impedance circuit usable in some embodiments of the variable impedance circuit discussed above. Referring to FIG. 6A, the dynamic impedance circuit 600A includes a number of capacitors 621A, 623A, and 625A, coupled between the energy source 610 and the load 620. Each of the capacitors 621A, 623A, and 625A is further coupled to a distinct one of the switches 621B, 623B, and 625B. Thus, the dynamic impedance circuit 600A may also be referred to as a switched capacitor network. Note that the capacitance of the capacitors 621A, 623A, and 625A may or may not be the same in different embodiments. Furthermore, there may be more or fewer capacitors and switches in other embodiments.

In some embodiments, the switches 621B, 623B, and 625B may be opened or closed in response to control signals from other devices, such as the timer 302 in FIG. 3, the energy transfer monitoring circuit 401 in FIG. 4, and the bus interface unit 501 in FIG. 5A. By closing or opening a selected number of the switches 621B, 623B, and 625B, these devices can select or deselect the respective capacitors 621A, 623A, and 625A, in order to change the impedance of the dynamic impedance circuit 600A. As discussed in details above, the impedance is adjusted in response to one or more system conditions and environmental changes monitored in order to increase the energy transfer from the energy source 610 to the load 630.

FIG. 6B illustrates an alternate embodiment of a dynamic impedance circuit. The dynamic impedance circuit 600B includes a number of inductors 641A, 643A, and 645A coupled in series between the energy source 610 and the load 630. In addition, each of the inductors 641A, 643A, and 645A is further coupled in parallel to a distinct one of the switches 641B, 643B, and 645B. Thus, the dynamic impedance circuit 600B may also be referred to as a switched inductor network. Each of the switches 641B, 643B, and 645B may be turned on or off to select or deselect the respective inductors 641A, 643A, and 645A. Note that the inductance of the inductors 641A, 643A, and 645A may or may not be the same in different embodiments. Furthermore, there may be more or fewer inductors and switches in other embodiments.

In some embodiments, the switches 641B, 643B, and 645B may be opened or closed in response to control signals from other devices, such as the timer 302 in FIG. 3, the energy transfer monitoring circuit 401 in FIG. 4, and the bus interface unit 501 in FIG. 5A. By closing or opening a selected number of the switches 641B, 643B, and 645B, these devices can deselect or select the respective inductors 641A, 643A, and 645A, in order to change the impedance of the dynamic impedance circuit 600B. As discussed in details above, the impedance is adjusted in response to one or more system conditions and environmental changes monitored in order to increase the energy transfer from the energy source 610 to the load 630.

FIG. 6C illustrates an alternate embodiment of a dynamic impedance circuit. The dynamic impedance circuit 600C includes a number of adjustable impedance modules 650 and 660 coupled in series between the energy source 610 and the load 630. The adjustable impedance module 650 is shown in details to illustrate the concept. One should appreciate that the one or more adjustable impedance modules 660 are substantially the same in structure as the adjustable impedance module 650, even though the impedance of each of the adjustable impedance modules 660 may or may not be the same as the adjustable impedance module 650.

In some embodiments, the adjustable impedance module 650 includes an adjustable inductor 654 and an adjustable capacitor 652. One end of the adjustable inductor 654 is coupled to the energy source 610 and the adjustable capacitor 652, while the other end of the adjustable inductor 654 is coupled to the next adjustable impedance module. The adjustable capacitor 652 is coupled between ground and the one end of the adjustable inductor 654. The inductance of the adjustable inductor 654 and the capacitance of the adjustable capacitor 652 may be adjusted in response to control signals from other devices, such as the timer 302 in FIG. 3, the energy transfer monitoring circuit 401 in FIG. 4, and the bus interface unit 501 in FIG. 5A. By adjusting the inductance and the capacitance, the impedance of the adjustable impedance module 650 can be changed. Likewise, the impedance of the other adjustable impedance modules 660 can be changed in similar manner. As a result, the overall impedance of the dynamic impedance circuit 600C can be adjusted in response to control signals from the other devices in order to increase energy transfer from the energy source 610 to the load 630.

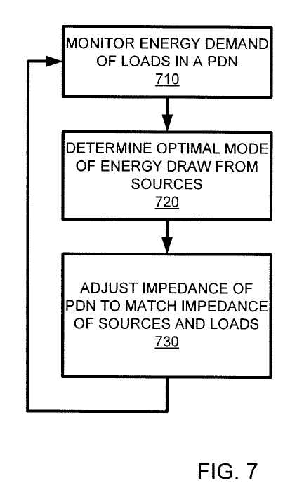

FIG. 7 illustrates one embodiment of a process to maximize the transfer of energy. The process may be performed by processing logic including software, hardware, or a combination of both. In some embodiments, processing logic includes a logic processing module embodied on a computer-readable medium executable by processing devices, such as the processing device 512 in the host 510 in FIG. 5B. Note that a logic processing module as used herein may include one or more processing modules. In some embodiments, processing logic includes hardware circuitries, such as the variable impedance circuit 201 discussed above with reference to FIG. 2. For example, some or all of the operations discussed below may be performed by various components illustrated in FIGS. 2-5B as discussed above.

Referring to FIG. 7, processing logic monitors the energy demand of one or more loads in a power distribution network (processing block 710). Based on the energy demand of the loads, processing logic determines an optimal mode of energy transfer from one or more energy sources (processing block 720). Then processing logic adjusts the impedance of the power distribution network to match the impedance of the energy sources and loads (processing block 730). As such, more energy may be transferred from the energy sources to the loads.

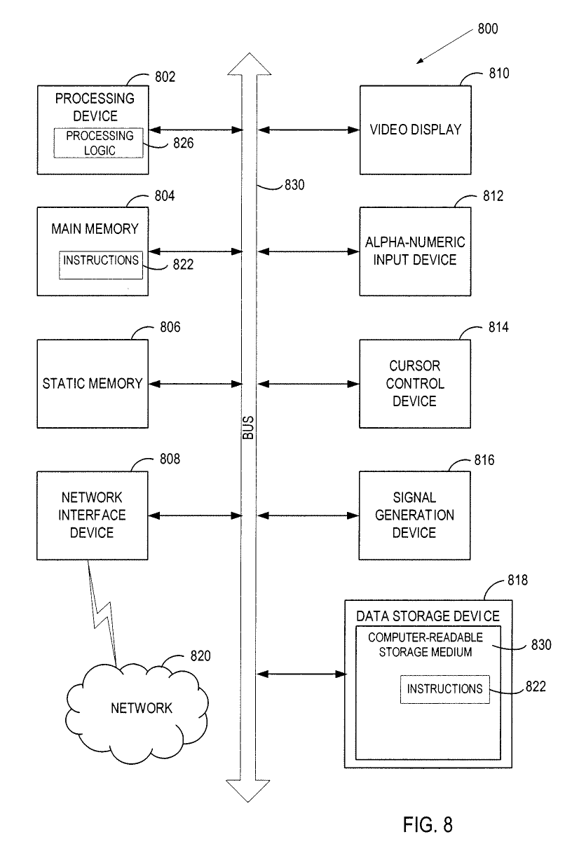

FIG. 8 illustrates a diagrammatic representation of one embodiment of a machine in the exemplary form of a computer system 800 within which a set of instructions, for causing the machine to perform any one or more of the methodologies discussed herein, may be executed. In alternative embodiments, the machine may be connected (e.g., networked) to other machines in a LAN, an intranet, an extranet, and/or the Internet. The machine may operate in the capacity of a server or a client machine in client-server network environment, or as a peer machine in a peer-to-peer (or distributed) network environment. The machine may be a personal computer (PC), a tablet PC, a set-top box (STB), a Personal Digital Assistant (PDA), a cellular telephone, a web appliance, a server, a network router, a switch or bridge, or any machine capable of executing a set of instructions (sequential or otherwise) that specify actions to be taken by that machine. Further, while only a single machine is illustrated, the term “machine” shall also be taken to include any collection of machines that individually or jointly execute a set (or multiple sets) of instructions to perform any one or more of the methodologies discussed herein.

The exemplary computer system 800 includes a processing device 802, a main memory 804 (e.g., read-only memory (ROM), flash memory, dynamic random access memory (DRAM) such as synchronous DRAM (SDRAM) or Rambus DRAM (RDRAM), etc.), a static memory 806 (e.g., flash memory, static random access memory (SRAM), etc.), and a data storage device 818, which communicate with each other via a bus 830.

Processing device 802 represents one or more general-purpose processing devices such as a microprocessor, a central processing unit, or the like. More particularly, the processing device may be complex instruction set computing (CISC) microprocessor, reduced instruction set computing (RISC) microprocessor, very long instruction word (VLIW) microprocessor, or processor implementing other instruction sets, or processors implementing a combination of instruction sets. Processing device 802 may also be one or more special-purpose processing devices such as an application specific integrated circuit (ASIC), a field programmable gate array (FPGA), a digital signal processor (DSP), network processor, or the like. The processing device 802 is configured to execute the processing logic 826 for performing the operations and steps discussed herein, such as the processing device 512 discussed above with reference to FIG. 5B. In some embodiments, the processing device 802 is configured to execute the processing logic 826 to monitor one or more system conditions and environmental changes of a system having a load and an energy source, and to dynamically control an impedance of a PDN coupled between the load and the energy source to increase energy transferred from the energy source to the load.

The computer system 800 may further include a network interface device 808. The computer system 800 also may include a video display unit 810 (e.g., a liquid crystal display (LCD) or a cathode ray tube (CRT)), an alphanumeric input device 812 (e.g., a keyboard), a cursor control device 814 (e.g., a mouse), and a signal generation device 816 (e.g., a speaker).

The data storage device 818 may include a computer-accessible storage medium 830 (also known as a computer-readable storage medium) on which is stored one or more sets of instructions (e.g., software 822) embodying any one or more of the methodologies or functions described herein. The software 822 may also reside, completely or at least partially, within the main memory 804 and/or within the processing device 802 during execution thereof by the computer system 800, the main memory 804 and the processing device 802 also constituting computer-accessible storage media. The software 822 may further be transmitted or received over a network 820 via the network interface device 808.

While the computer-readable storage medium 830 is shown in an exemplary embodiment to be a single medium, the term “computer-readable storage medium” should be taken to include a single medium or multiple media (e.g., a centralized or distributed database, and/or associated caches and servers) that store the one or more sets of instructions. The term “computer-readable storage medium” shall also be taken to include any medium that is capable of storing, encoding or carrying a set of instructions for execution by the machine and that cause the machine to perform any one or more of the methodologies of the present invention. The term “computer-readable storage medium” shall accordingly be taken to include, but not be limited to, solid-state memories, optical and magnetic media, etc.

Thus, a method and apparatus for dynamically controlling impedance to maximize the available energy from energy sources has been described. It will be apparent from the foregoing description that aspects of the present invention may be embodied, at least in part, in software. That is, the techniques may be carried out in a computer system or other data processing system in response to its processing device executing sequences of instructions contained in a memory. In various embodiments, hardwired circuitry may be used in combination with software instructions to implement the present invention. Thus, the techniques are not limited to any specific combination of hardware circuitry and software or to any particular source for the instructions executed by the data processing system. In addition, throughout this description, various functions and operations may be described as being performed by or caused by software code to simplify description. However, those skilled in the art will recognize what is meant by such expressions is that the functions result from execution of the code by a processing device or controller.

A machine-readable medium (also referred to as a computer-readable medium) can be used to store software and data which when executed by a data processing system causes the system to perform various methods of the present invention. This executable software and data may be stored in various places including, for example, read-only memory (ROM) and programmable memory or any other device that is capable of storing software programs and/or data.

Thus, a computer-readable medium includes any mechanism that provides (i.e., stores and/or transmits) information in a form accessible by a machine (e.g., a computer, network device, personal digital assistant, manufacturing tool, any device with a set of one or more processing devices, etc.). For example, a computer-readable medium includes recordable/non-recordable media (e.g., read only memory (ROM); random access memory (RAM); magnetic disk storage media; optical storage media; flash memory devices; etc.); etc.

Some portions of the detailed descriptions above are presented in terms of algorithms and symbolic representations of operations on data bits within a computer memory. These algorithmic descriptions and representations are the means used by those skilled in the data processing arts to most effectively convey the substance of their work to others skilled in the art. An algorithm is here, and generally, conceived to be a self-consistent sequence of operations leading to a desired result. The operations are those requiring physical manipulations of physical quantities. Usually, though not necessarily, these quantities take the form of electrical or magnetic signals capable of being stored, transferred, combined, compared, and otherwise manipulated. It has proven convenient at times, principally for reasons of common usage, to refer to these signals as bits, values, elements, symbols, characters, terms, numbers, or the like.

It should be borne in mind, however, that all of these and similar terms are to be associated with the appropriate physical quantities and are merely convenient labels applied to these quantities. Unless specifically stated otherwise as apparent from the following discussion, it is appreciated that throughout the description, discussions utilizing terms such as “processing” or “computing” or “calculating” or “determining” or “displaying” or “controlling” or “monitoring” or the like, refer to the action and processes of a computer system, or similar electronic computing device, that manipulates and transforms data represented as physical (electronic) quantities within the computer system's registers and memories into other data similarly represented as physical quantities within the computer system memories or registers or other such information storage, transmission, or display devices.

The present invention also relates to apparatus for performing the operations herein. This apparatus may be specially constructed for the required purposes, or it may comprise a general-purpose computer selectively activated or reconfigured by a computer program stored in the computer. Such a computer program may be stored in a computer-readable storage medium, such as, but is not limited to, any type of disk including floppy disks, optical disks, CD-ROMs, and magnetic-optical disks, read-only memories (ROMs), random access memories (RAMs), EPROMs, EEPROMs, magnetic or optical cards, or any type of media suitable for storing electronic instructions, and each coupled to a computer system bus.

The algorithms and displays presented herein are not inherently related to any particular computer or other apparatus. Various general-purpose systems may be used with programs in accordance with the teachings herein, or it may prove convenient to construct more specialized apparatus to perform the required operations. The required structure for a variety of these systems will appear from the description below. In addition, the present invention is not described with reference to any particular programming language. It will be appreciated that a variety of programming languages may be used to implement the teachings of the invention as described herein.

It should be appreciated that references throughout this specification to “one embodiment” or “an embodiment” means that a particular feature, structure or characteristic described in connection with the embodiment is included in at least one embodiment of the present invention. Therefore, it is emphasized and should be appreciated that two or more references to “an embodiment” or “one embodiment” or “an alternative embodiment” in various portions of this specification are not necessarily all referring to the same embodiment. Furthermore, the particular features, structures or characteristics may be combined as suitable in one or more embodiments of the invention. In addition, while the invention has been described in terms of several embodiments, those skilled in the art will recognize that the invention is not limited to the embodiments described. The embodiments of the invention can be practiced with modification and alteration within the scope of the appended claims. The specification and the drawings are thus to be regarded as illustrative instead of limiting on the invention.

We claim:

1. A method comprising:
monitoring one or more system conditions and environmental changes of a system comprising a load, an energy source, and a power delivery network (PDN) coupled between the load and the energy source; and
dynamically controlling, by processing logic, an impedance of the PDN based on results of the monitoring to increase energy transferred from the energy source to the load.

2. The method of claim 1, wherein dynamically controlling impedance of the PDN comprises:
adjusting the impedance of the PDN to match an impedance of the PDN and the load with an impedance of the energy source.

3. The method of claim 2, wherein said adjusting is performed periodically.

4. The method of claim 1, wherein the one or more system conditions comprises at least one of the impedance of the PDN, an impedance of the energy source, charge flow between the energy source and the load, and power demand of the load.

5. The method of claim 1, wherein the environmental changes comprise at least one of temperature change and humidity change.

6. The method of claim 1, wherein the processing logic comprises a variable impedance circuit of the PDN.

7. The method of claim 1, wherein the processing logic comprises a processing device in a host external to the PDN, the processing device operable to determine an appropriate value of the impedance of the PDN.

8. The method of claim 1, wherein the processing logic comprises a logic processing module embodied on a computer-readable medium to determine an appropriate value of the impedance of the PDN.

9. An apparatus comprising:
a power distribution network (PDN) coupled between an energy source and a load, the PDN comprising
a variable impedance circuit, whose impedance is adjusted dynamically in response to a set of one or more system conditions and environmental changes to increase energy transferred from the energy source to the load.

10. The apparatus of claim 9, wherein the PDN further comprises:
a voltage regulation module to regulate voltage supply from the energy source; and
a filter and energy storage device to prevent over voltage and under voltage conditions.

11. The apparatus of claim 9, wherein the variable impedance circuit operates in an autonomous mode, and the variable impedance circuit comprises:
a dynamic impedance circuit; and
a timer to keep track of predetermined time intervals and to send signals to the dynamic impedance circuit to cause the dynamic impedance circuit to change an impedance of the dynamic impedance circuit at the predetermined time intervals.

12. The apparatus of claim 9, wherein the variable impedance circuit operates in an autonomous mode, and the variable impedance circuit comprises:
a dynamic impedance circuit; and
an energy transfer monitoring circuit to monitor energy output of the energy source, wherein an impedance of the dynamic impedance circuit is adjusted based on the energy output of the energy source to increase the transfer of energy from the energy source to the load.

13. The apparatus of claim 9, wherein the variable impedance circuit operates in a command mode, and the variable impedance circuit comprises:
a dynamic impedance circuit; and
a bus interface unit, coupled to a host external to the variable impedance circuit, to receive commands from the host and to adjust an impedance of the dynamic impedance circuit in response to the commands received.

14. The apparatus of claim 13, wherein the bus interface unit comprises one or more sensors to monitor the one or more system conditions and environmental changes, and the bus interface unit adjusts the impedance of the dynamic impedance circuit in response to the one or more system conditions and the environmental changes.

15. The apparatus of claim 13, wherein the host comprises one or more sensors to monitor one or more system conditions and environmental changes and sends the commands to the bus interface unit in response to the one or more system conditions and environmental changes.

16. The apparatus of claim 15, wherein the host comprises a processing device to determine a dynamic impedance value based on the one or more system conditions and environmental changes monitored, wherein the host sends the dynamic impedance value determined to the dynamic impedance circuit.

17. The apparatus of claim 9, wherein the variable impedance circuit comprises:
a switched capacitor network comprising
a plurality of capacitors coupled to each other in parallel; and
a plurality of switches, each of the plurality of switches coupled between a distinct one of the plurality of capacitors and ground.

18. The apparatus of claim 9, wherein the variable impedance circuit comprises:
a switched inductor network comprising
a plurality of inductors coupled to each other in series; and
a plurality of switches, each of the plurality of switches coupled to a distinct one of the plurality of inductors in parallel.

19. The apparatus of claim 9, wherein the variable impedance circuit comprises:
a set of one or more adjustable impedance modules, each of the set of one or more adjustable impedance modules comprising
an adjustable inductor; and
an adjustable capacitor coupled between the adjustable inductor and ground.

20. The apparatus of claim 9, further comprising:
the load; and
the energy source.

21. A computer-readable medium that provides instructions that, when executed by a processing device, causes the processing device to perform operations comprising:
monitoring one or more system conditions and environmental changes of a system comprising a load and an energy source; and
dynamically controlling an impedance of the load based on results of the monitoring to increase energy transferred from the energy source to the load.

22. The computer-readable medium of claim 21, wherein dynamically controlling impedance of the load comprises:
adjusting the impedance of the load to substantially match an impedance of the energy source.

23. The computer-readable medium of claim 22, wherein said adjusting is performed periodically.

24. The computer-readable medium of claim 21, wherein the one or more system conditions comprises at least one of an impedance of the energy source, charge flow between the energy source and the load, and power demand of the load.

25. The computer-readable medium of claim 24, wherein the environmental changes comprise at least one of temperature change and humidity change.

26. An apparatus comprising:
means for monitoring one or more system conditions and environmental changes of a system comprising a load, an energy source, and a power delivery network (PDN) coupled between the load and the energy source; and
means for increasing energy transferred from the energy source to the load to dynamically vary an impedance of the PDN in response to the one or more system conditions and environmental changes.
